(19) United States
(12) Patent Application Publication
(10) Pub. No.: US 2014/0062251 A1
(43) Pub. Date: Mar. 6, 2014

(54) EMBEDDED MAGNET TYPE ELECTRIC MOTOR ROTOR

(71) Applicant: FANUC CORPORATION, Minamitsuru-gun (JP)

(72) Inventors: Yohei ARIMATSU, Minamitsuru-gun (JP); Shinobu TAKANO, Minamitsuru-gun (JP)

(73) Assignee: FANUC CORPORATION, Minamitsuru-gun (JP)

(21) Appl. No.: 14/019,093

(22) Filed: Sep. 5, 2013

(30) Foreign Application Priority Data
Sep. 6, 2012 (JP) 2012-196383

(51) Int. Cl. H02K 1/28

(52) U.S. Cl. CPC H02K 1/28
USPC 310/216.004

(57) ABSTRACT

An embedded magnet type electric motor rotor (10) including with a core (11) which is formed by laminating a plurality of electrical steel sheets, magnets (M) which are arranged in a plurality of magnet slots (30) which are formed in a circumferential direction of the core, and non-core parts (35, 36) which are positioned in clearances between the magnet slots and the magnets which are arranged in the magnet slots, wherein in the rotor, reinforcing parts (40) which reinforce the core in an axial direction are provided at least at two non-core parts of the core.

### BACKGROUND OF INVENTION

1. Field of the Invention

The present invention relates to an embedded magnet type electric motor rotor. In particular, the present invention relates to an embedded magnet type electric motor rotor including a core which is formed by laminating a plurality of electromagnetic steel sheets, magnets which are arranged in a plurality of magnet slots which are formed in a circumferential direction of the core, and non-core parts which are positioned in clearances between the magnet slots and the magnets which are arranged in the magnet slots.

2. Description of Related Art

A core of a general embedded magnet type rotor is comprised of a plurality of disk-shaped electromagnetic steel sheets which are laminated and then formed into a cylindrical shape. Further, a core is formed with a plurality of magnet slots in its circumferential direction. In the magnet slots, magnets are arranged. Usually, at one pole, a plurality of magnets are arranged in a magnet slot. However, when it is required that the rotor rotate at a high speed, at one pole, a plurality of magnets are arranged in a plurality of magnet slots. In this case, the poles of the plurality of magnets at the one pole are oriented in the same direction.

Usually, a plurality of magnets are arranged in the axial direction. As opposed to this, if using magnets which are elongated in the axial direction, eddy current loss of the magnets themselves cause the magnets to generate heat and rise in temperature. Further, elongated magnets are low in work efficiency at the time of manufacture. Further, such magnets are also hard to procure. Furthermore, when the boundary surfaces of a plurality of elongated magnets are present at the same positions in the axial direction, due to the repulsion force which acts between elongated magnets, the electromagnetic steel sheets which form the core will crack or clearances will be formed between the electrical steel sheets. As a result, the core will sometimes separate and the rotor will break.

In this regard, sometimes a rotor and stator is directly assembled into a machine tool etc. as a built-in motor. A rotor of such a built-in motor is directly delivered from the manufacturer to the purchaser separate from the shaft. Further, the purchaser inserts the shaft into the rotor for final assembly. To avoid the electromagnetic steel sheets of the core from separating at the time of such delivery and assembly of the rotor, a certain degree of strength or more is required for the core.

Further, in general, the spindle of a machine tool is thick and is required to be high in rigidity. For this reason, when a rotor is built into a spindle of a machine tool as a part of a built-in motor, it is required that the inside diameter of the rotor be larger. In particular, this tendency is greater when a spindle is rotated at a high speed. Further, if a rotor is made large in inside diameter, the core falls in cross-sectional area, so also falls in strength.

Japanese Patent Publication No. 9-200982A discloses a core in which rivet holes are formed outward from the magnets. Further, bolts etc. are passed through these rivet holes, then the core is clamped from the two ends in the axial direction so as to prevent the electromagnetic steel sheets of the core from separating in the lamination direction.

In this regard, non-core parts are formed between the magnet slots and the magnets which are arranged in the magnet slots. These non-core parts are located at clearances which are formed between the two side parts of the magnet slots and the two side parts of the magnets. Due to the non-core parts, more magnetic flux from the magnets passes through the core of the stator.

In general, the non-core parts are empty spaces. Sometimes, a binder for adhering the magnets is slightly coated at the non-core parts. Alternatively, as disclosed in Japanese Patent Publication No. 2006-109683A and Japanese Patent Publication No. 5-236684A, sometimes a resin for fastening the magnets to the magnet slots is filled in the non-core parts. Such a resin is sufficient to fill the clearances between the magnet slots and the magnets so that the magnets do not move in the magnet slots.

In this connection, to make the rotor rotate at a high speed, the maximum value of the stress which occurs at the rotor at the highest speed has to be kept down to below the allowable stress value which is determined from the material of the rotor etc. However, the rivet holes which are disclosed in Japanese Patent Publication No. 9-200982A are unsuitable for raising the speed. Furthermore, the stress which occurs at the time of rotation of the rotor becomes maximum near the rivet holes. Therefore, to keep down the stress, rivet holes are preferably eliminated.

Further, filling a binder in the resin filling parts in the magnet slots in Japanese Patent Publication No. 2006-109683A and Japanese Patent Publication No. 5-236684A is believed effective in that the binder supports the core and therefore the rotor is kept from breaking due to centrifugal force. However, such an effect is limited to the case where the rotor is rotated at a low speed. Therefore, when the rotor is rotated at a high speed, it is meaningless to use a binder or other resin to fill the clearances. In other words, when a rotor is rotated at a high speed, a binder or other resin cannot support the weight of the core and the electromagnetic steel sheets which form the core.

Furthermore Japanese Patent Publication No. 5-236684A discloses to stuff a solid material into the empty spaces when the cross-sectional areas of the empty spaces in the magnet slots are large. This solid material has a specific gravity equal to the specific gravity of the core. Its shape is not clearly defined. Therefore, if just stuffing this solid material into the empty spaces, the core becomes greater in weight and the strength conversely falls.

The present invention was made in consideration of this situation and has as its object to provide an embedded magnet type electric motor rotor which is large in inside diameter, can rotate at a high speed, and prevents breakage of the core in the lamination direction without requiring rivet holes.

### SUMMARY OF INVENTION

To achieve the above-mentioned object, according to a first aspect, there is provided an embedded magnet type electric motor rotor including a core which is formed by laminating a plurality of electrical steel sheets, magnets which are arranged in a plurality of magnet slots which are formed in a circumferential direction of the core, and non-core parts which are positioned in clearances between the magnet slots and the magnets which are arranged in the magnet slots, wherein in the rotor, reinforcing parts which reinforce the core in an axial direction are provided at least at two non-core parts of the core.

According to a second aspect, there is provided the first aspect wherein a reinforcing part is comprised of at least a first material and a second material, the first material is a material which has fluidity when filled in a non-core part and which hardens after filling, and the second material is at least one elongated member which extends at least partially in an axial direction at the non-core part.

According to a third aspect, there is provided the second aspect wherein the second material is fiber.

According to a fourth aspect, there is provided the second aspect wherein the second material is a fabric-shaped, mat-shaped, sheet-shaped, film-shaped, or felt-shaped material.

According to a fifth aspect, there is provided the second aspect wherein the second material is a string-shaped, rod-shaped, or cord-shaped material.

According to a sixth aspect, there is provided the second aspect wherein the second material is a rod-shaped or tube-shaped material.

According to a seventh aspect, there is provided the first aspect wherein a reinforcing part is an insert member which is inserted into a non-core part and extends from one end to the other end of the core, and tension is applied to the insert member in an axial direction of the core while the insert member is fastened to one end and the other end of the core.

According to an eighth aspect, there is provided the first aspect wherein a reinforcing part is a carbon fiber sheet which is inserted into a non-core part, extends from one end to the other end of the core, and is impregnated with a thermosetting resin and is fastened to the non-core part by heating to harden the carbon fiber sheet.

According to a ninth aspect, there is provided an electric motor which carries a rotor of an aspect of any one of the first to eighth aspects.

These objects, features, and advantages of the present invention and other objects, features, and advantages will become further clearer from the detailed description of typical embodiments of the present invention which are shown in the attached drawings.

### BRIEF DESCRIPTION OF THE DRAWINGS

FIG. 1 is a vertical cross-sectional view of an electric motor which is provided with a rotor according to the present invention.

FIG. 2 is a perspective view of a rotor according to the present invention.

FIG. 3A is a horizontal cross-sectional view of a rotor which is shown in FIG. 1.

FIG. 3B is a horizontal cross-sectional view of another rotor.

FIG. 4 is a partial perspective view of a core of a rotor.

FIG. 5 is a first partial enlarged perspective view of a core.

FIG. 6 is a second partial enlarged perspective view of a core.

FIG. 7 is a third partial enlarged perspective view of a core.

FIG. 8 is a fourth partial enlarged perspective view of a core.

FIG. 9 is a fifth partial enlarged perspective view of a core.

FIG. 10 is a sixth partial enlarged perspective view of a core.

FIG. 11 is a seventh partial enlarged perspective view of a core.

FIG. 12 is an eighth partial enlarged perspective view of a core.

FIG. 13 is a partial perspective view of another core of a rotor.

FIG. 14 is a ninth partial enlarged perspective view of a core.

### DETAILED DESCRIPTION

Below, the attached drawings will be referred to so as to explain embodiments of the present invention. In the following drawings, the same members are assigned similar reference notations. To facilitate understanding, these drawings are suitably changed in scale.

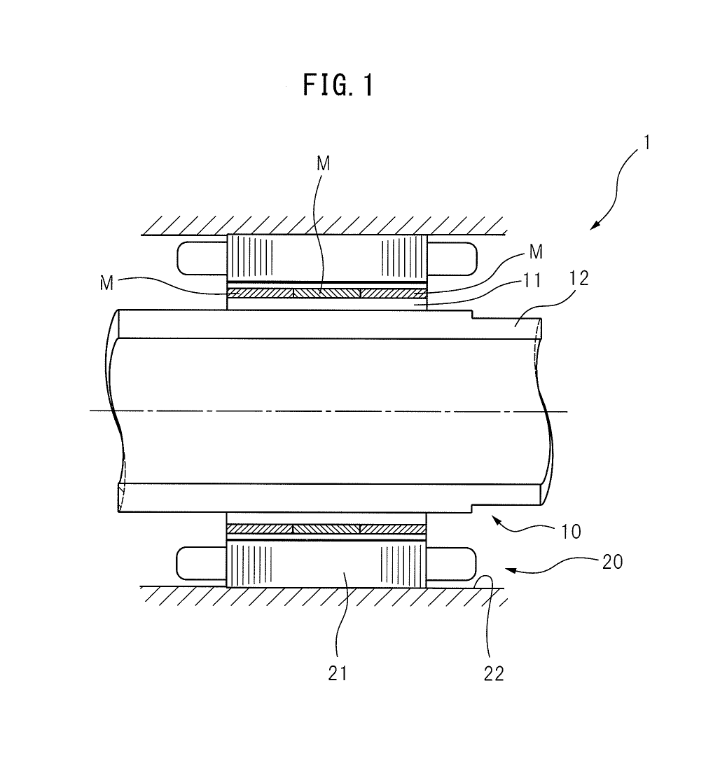

FIG. 1 is a vertical cross-sectional view of an electric motor which is provided with a rotor according to the present invention. An electric motor 1 which is shown in FIG. 1 includes a rotor 10 and a stator 20 which is arranged around the rotor 10. As shown in FIG. 1, the stator 20 is assembled into a housing 22 of a machine tool etc. Further, the rotor 10 mainly includes a core 11 and a rotary shaft 12 which is inserted into the core 11. Furthermore, as can be seen from FIG. 1, the core 11 of the rotor 10 is arranged so as to face a stator-use core 21 of the stator 20.

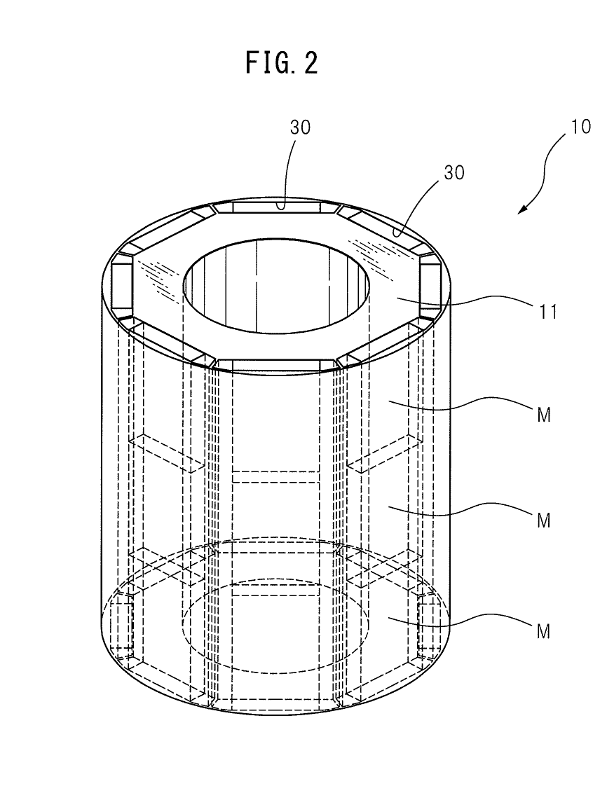

FIG. 2 is a perspective view of a rotor according to the present invention. The core 11 of the rotor 10 is formed by laminating a plurality of disk-shaped electromagnetic steel sheets and fastening these electromagnetic steel sheets together by swaging, welding, bonding, etc. Therefore, as shown in FIG. 2, the core 11 is cylindrical in shape.

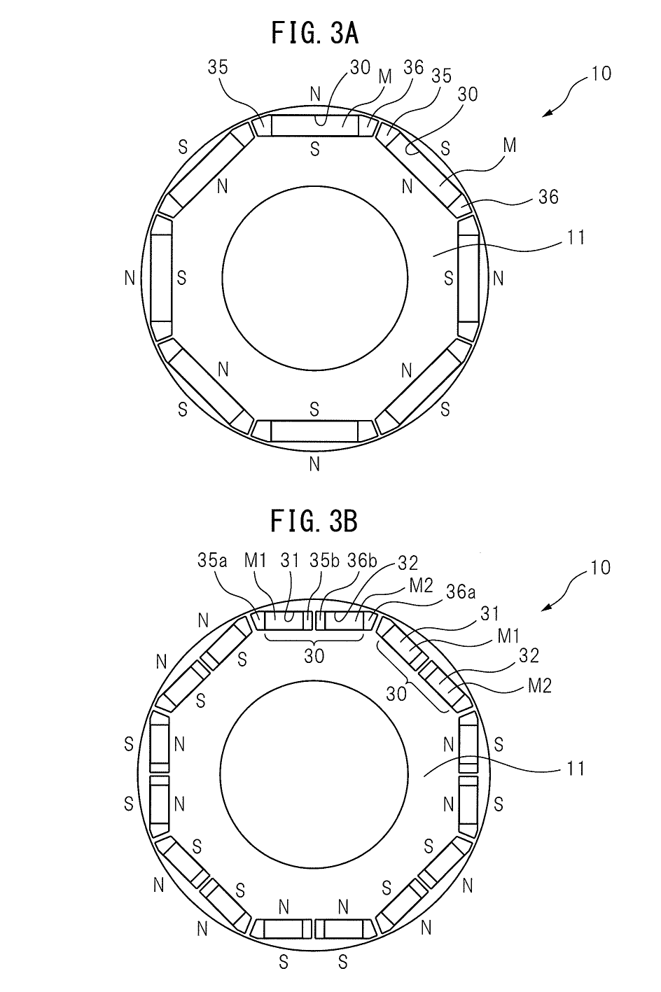

FIG. 3A is a horizontal cross-sectional view of the rotor which is shown in FIG. 2. In FIG. 3A, a plurality of magnet slots 30 are formed in a circumferential direction of the core 11 at equal intervals. As can be seen by referring again to FIG. 2, the respective magnet slots 30 extend from one end to the other end of the core 11 in the axial direction.

Further, in these magnet slots 30, magnets M which have rectangular cross-sections are arranged. In each of the magnet slots 30, a plurality of magnets M are arranged in the axial direction of the core 11. The poles of the plurality of magnets M in one magnet slot 30 are equal to each other. However, as can be seen from FIG. 3A, the poles of the plurality of magnets M in one magnet slot 30 differ from the poles of the plurality of magnets M in the adjoining magnet slots 30. Note that even the case where a single elongated magnet arranged in one magnet slot 30 is deemed to be included in the scope of the present invention.

Further, FIG. 3B is a horizontal cross-sectional view of another rotor. In FIG. 3B, a plurality of pairs of magnet slots 31 and 32 are formed in the circumferential direction of the core 11 at equal intervals. These magnet slots 31 and 32 have same pole magnets M1 and M2 arranged in the same way as explained above. Note that in this specification, these same pole magnet slots 31 and 32 will be referred to all together as the “magnet slots 30”.

In the same way as explained with reference to FIG. 3A, the poles of the pluralities of magnets M1 and M2 in a pair of magnet slots 31 and 32 are equal to each other. However, the poles of the pluralities of magnets M in the pair of magnet slots 31 and 32 are different from the poles of the pluralities of magnets M1 and M2 in the other adjoining pairs of magnet slots 31 and 32. Note that, in FIG. 3B, for simplification, the poles of part of the magnets M1 and M2 are not shown. Further, the example which is shown in FIG. 3B is advantageous when the rotor 10 has to be rotated at a high speed.

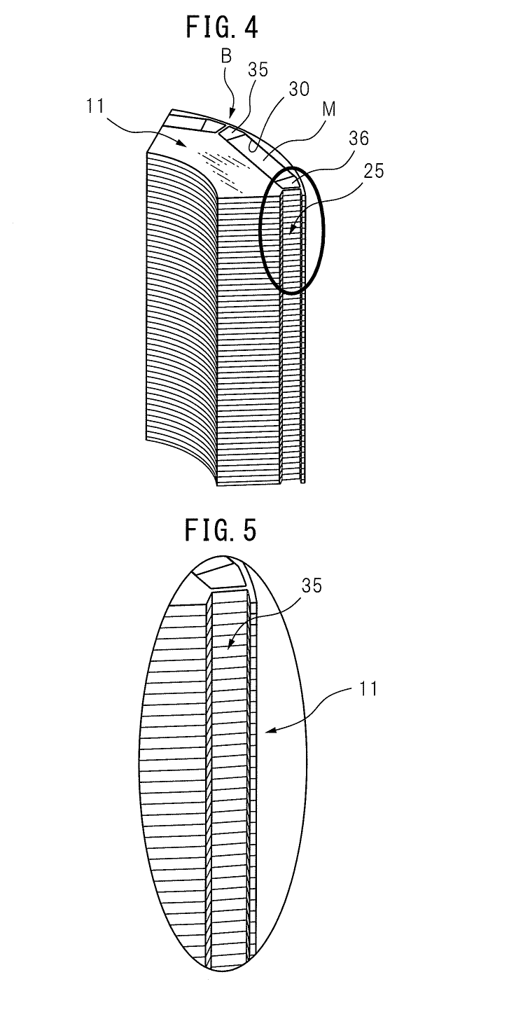

In this regard, FIG. 4 is a partial perspective view of a core of a rotor, while FIG. 5 is first partial enlarged perspective view of a core. As can be seen from these figures, the two side parts of the magnet slots 30 stick out more than the two side parts of the corresponding magnets M. Therefore, clearances are formed between the two side parts of the magnet slots 30 and the two side parts of the magnets M. The locations corresponding to the clearances between the magnet slots 30 and the magnets M are respectively called “non-core parts 35 and 36”.

If there are no non-core parts 35 and 36, part of the magnetic flux from a certain magnet passes through the bridge part B between poles and takes a short cut to the opposite side magnet without passing through the stator-use core 21. Therefore, such non-core parts 35 and 36 perform the role of preventing leakage of magnetic flux and suppressing short circuits of the magnets M.

FIG. 4 and FIG. 5 show cross-sections of one non-core part 35 of one magnet slot 30. The non-core parts 35 extend from one end of the core 11 to a not shown other end in the axial direction of the core 11. In FIG. 5, the non-core parts 35 are empty spaces which are not filled with other parts or materials.

In the above-mentioned FIG. 3B as well, non-core parts 35a and 35b are formed at the two side parts of the magnet slots 31. Similarly, non-core parts 36a and 36b are formed at the two side parts of the magnet slots 32.

Below, the case where one non-core part 35 is filled with a specific material will be explained. To secure balance of the rotor 10, the other non-core parts 35 which are arranged in the circumferential direction at equal intervals are filled with similar materials as this non-core parts 35. Due to this, vibration and noise at the time of rotation of the rotor 10 are suppressed and malfunction of the parts of the machine tool due to vibration can be avoided.

Further, the other non-core parts 36, 35a, 35b, 36a, and 36b may also be filled with specific materials. In this case, the other non-core parts 36, 35a, 35b, 36a, and 36b which are arranged in the circumferential direction at equal intervals are filled with similar materials. Only naturally, all of the non-core parts 35, 36, 35a, 35b, 36a, and 36b may be filled with material.

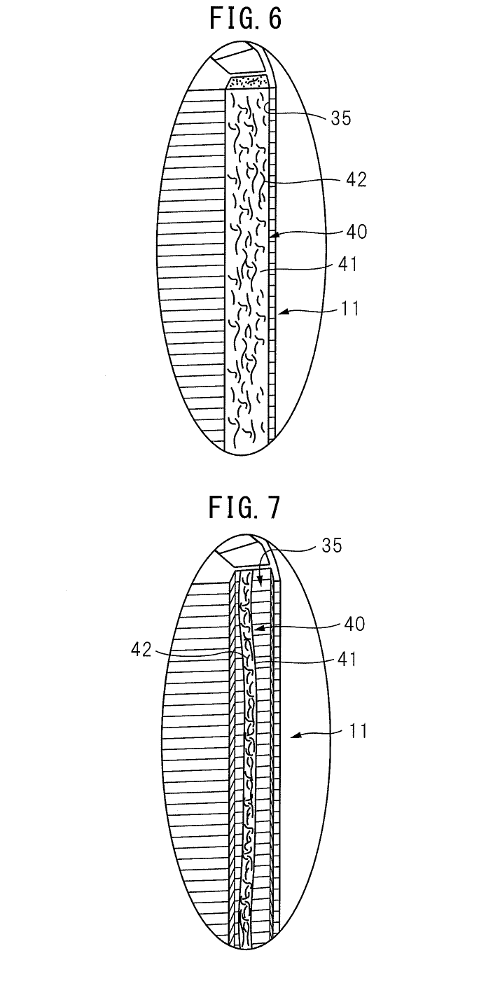

FIG. 6 is a second partial enlarged perspective view of a core. In FIG. 6, a mixture of the first material 41 as a base member and a second material 42 for reinforcing the core 11 in the axial direction is filled in the non-core part 35 as a whole as a reinforcing part 40. The first material 41 and second material 42 are both nonmagnetic members. The second material 42 is an elongated member which extends at least partially in the axial direction at the non-core part 35.

The first material 41 is for example a thermosetting resin. As examples of a thermosetting resin, epoxy, phenol, polyimide, polyurethane, polyester, and silicone may be mentioned. When the first material 41 is a thermosetting resin, the first material 41 is supplied to the non-core part 35 before hardening by filling, coating, spraying, impregnation, jetting, or other means. Then, the first material 41 is heated to make it harden.

Alternatively, the first material 41 may be a thermoplastic resin. As an example of a thermoplastic resin, vinyl-based resins as a whole, a polyamide, polyamidimide, and other resin materials which are used in injection molding may be mentioned.

When the first material 41 is a thermoplastic resin, the temperature is raised to increase the fluidity, then the thermoplastic resin is supplied to the non-core part 35 by filling, coating, spraying, impregnation, jetting, or other means. Then, the temperature is lowered to allow the first material 41 to harden.

Alternatively, the first material 41 may be another material which can be raised in fluidity by a solvent, for example, water, alcohols, ketones, aromatic hydrocarbons, acetic acid esters, cyclohexanes, etc. In this case, a solvent is used to increase the fluidity, then the material is supplied to the non-core part 35 by filling, coating, spraying, impregnation, jetting, or other means. Then, heating is used to make the solvent evaporate and harden the material. Further, all sorts of resins which can be utilized as binders may be used as the first material 41.

Further, the second material 42 which is shown in FIG. 6 is comprised of staple fibers. As such staple fibers, glass fiber, aramide fiber, high molecular weight polyethylene fiber, carbon fiber, and other natural fiber, such as wood fiber or fiber or cotton may be mentioned. Staple fiber is mixed with the first material 41 and supplied together to the non-core part 35.

Alternatively, as shown in FIG. 7 which is a third partial enlarged perspective view of a core, a mixture of staple fiber and the first material 41 may be coated or sprayed as the reinforcing part 40 on the inside wall of the non-core part 35 in the axial direction. Further, if hardening the first material 41, the presence of the second material 42 enables the strength of the core 11 in the axial direction to be raised.

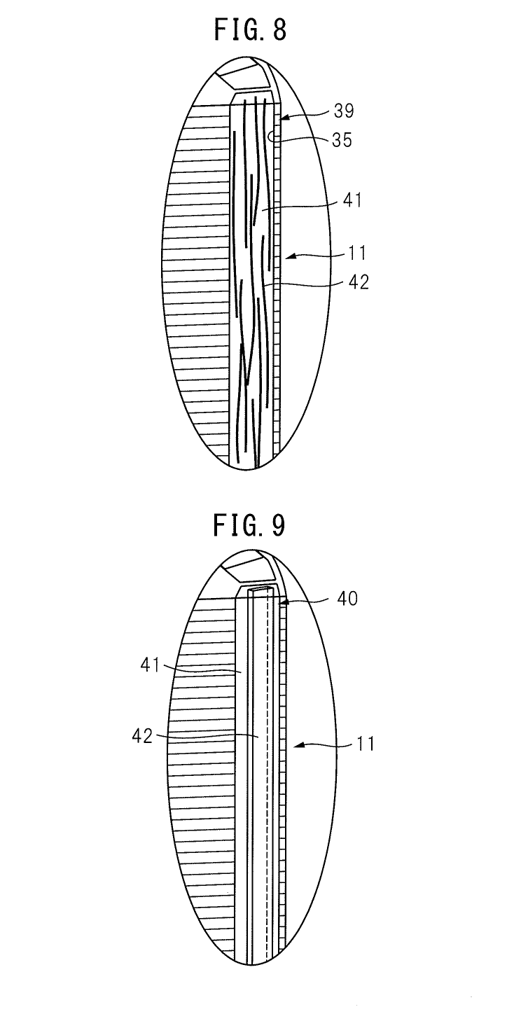

Further, FIG. 8 is a fourth partial enlarged perspective view of a core. In FIG. 8, a mixture of the above-mentioned first material 41 and the second material 42 as filament fiber is filled as a reinforcing part 40 in the non-core part 35. The type of the filament fiber is the same as the type of the above-mentioned stable fiber. When the fiber is relatively long in this way, the first material 41 is impregnated in the filament fiber in advance. Further, the filament fiber is coated or adhered to the inside walls of the non-core part 35 or stuffed in the non-core part 35. Further, when the filament fiber is shorter than the axial direction length of the core 11, preferably a plurality of fibers are arranged partially overlapped and fastened in the non-core part 35 without becoming discontinuous in the axial direction. Due to this, the strength of the core 11 in the axial direction can be further increased.

In the embodiments which are shown from FIG. 6 to FIG. 8, staple fiber or filament fiber are distributed from one end to the other end of the core 11 with the first material 41 inside the non-core part 35. Due to such staple fiber or filament fiber, the strength of the core 11 in the axial direction can be further increased. Therefore, separation of the electromagnetic steel sheets of the core 11 in the axial direction can be avoided. As explained above, the staple fiber and filament fiber are preferably not discontinuous in the axial direction in the non-core part 35. Due to this, it is possible to raise the strength of the core 11 in the axial direction along the length part of the core 11 as a whole.

FIG. 9 is a fifth partial enlarged perspective view of a core. In FIG. 9, a fabric-shaped, mat-shaped, sheet-shaped, film-shaped, or felt-shaped second material 42 is inserted into a non-core part 35. Then, the first material 41 is filled into the non-core part 35 and hardened, whereby a reinforcing part 40 is formed. The second material 42 may be a single material or a plurality. As the second material 42 which is shown in FIG. 9, a material which is used for insulating paper may be mentioned. Such a material is for example made of an aramide, PET, glass cloth, polyphenylene sulfide, etc. Further, carbon fiber may also be utilized. In the example which is shown in FIG. 9, there is no need to mix the fabric-shaped second material 42 cut into a suitable shape with the first material 41, so the reinforcing part 40 can be prepared relatively simply.

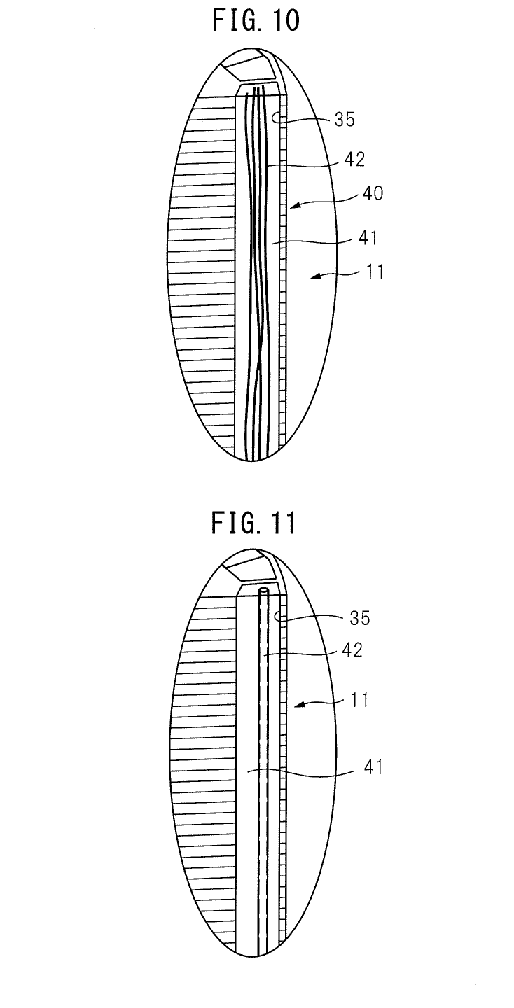

FIG. 10 is a sixth partial enlarged perspective view of a core. In FIG. 10, the above-mentioned first material 41 and a second material 42 as a cord or string are arranged in a non-core part 35. The cord or string is cut in advance to suitable lengths, then one or more cords or strings are inserted into the non-core part 35. Further, the first material 41 is filled in the non-core part 35 and hardened whereby a reinforcing part 40 is formed. Alternatively, one or more cords or strings may be coated with the first material 41, then these cords or strings inserted into a non-core part 35 and then the first material 41 hardened. The second material 42 as the cord or string is, for example, prepared from an aramide, PET, glass cloth, polyphenylene sulfide, or carbon fiber. In the example which is shown in FIG. 10, there is no need to mix the second material 42 as the cords or strings cut into suitable lengths with the first material 41, so the reinforcing part 40 can be prepared relatively simply.

Further, in the example which is shown in FIG. 9 and FIG. 10, so long as the length of the second material 42 is the length of the core 11 or more, it is sufficient to insert as little as one second material 42 into one non-core parts 35. Only naturally, in the example which is shown in FIG. 9 and FIG. 10, a plurality of second materials 42 may be inserted into one non-core part 35 to raise the strength of the core 11 in the axial direction.

Furthermore, FIG. 11 is a seventh partial enlarged perspective view of a core. In FIG. 11, the second material 42 of the reinforcing part 40 is a rod or tube. One or more second materials 42 as rods or tubes cut into suitable lengths in advance are inserted into the non-core part 35. Further, the first material 41 is filled into the non-core part 35 and hardened whereby a reinforcing part 40 is formed.

FIG. 12 is an eighth partial enlarged perspective view of a core. As shown in FIG. 12, one or more rods or tubes are coated with a first material 41, then these rods or tubes are inserted into the non-core part 35, then the first material 41 is made to harden. The second material 42 which is shown in FIG. 9 to FIG. 12 is preferably long to the extent of the length of the core 11 in the axial direction. If the second material 42 which is shown in FIG. 9 to FIG. 12 is shorter than the axial direction length of the core 11, preferably a plurality of second materials 42 are arranged partially overlapped so that the second materials 42 are not discontinuous over the entire axial direction length of the core 11. Due to this, the strength of the core 11 can be prevent from becoming locally smaller and the strength of the core 11 in the axial direction can be raised over the entire length part of the core 11.

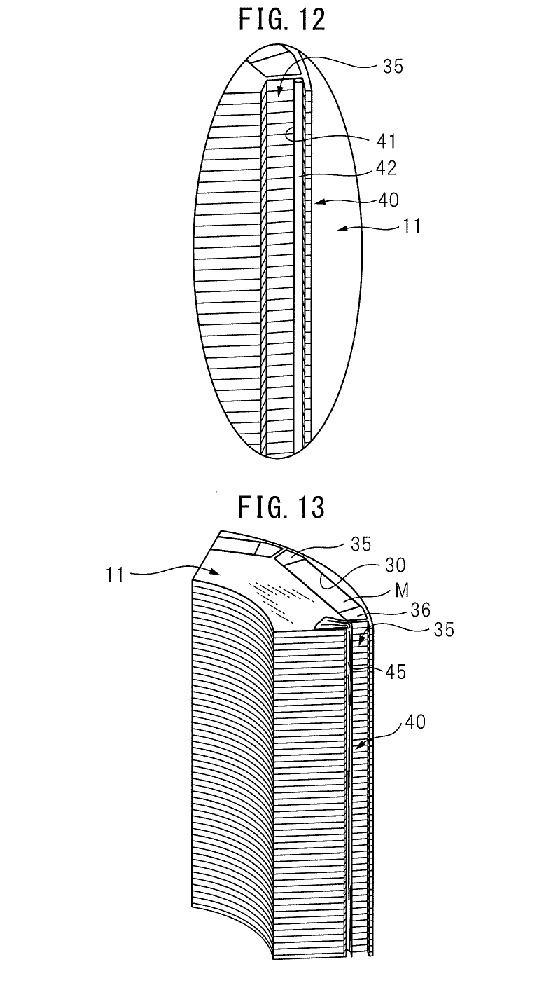

FIG. 13 is a partial perspective view of another core of a rotor. In FIG. 13, an insert member 45 which extends from one end to the other end of the core 11 is inserted into a non-core part 35, then the insert member 45 is bent and fastened to one end and the other end of the core 11 by a binder etc. The insert member 45 may be a fabric, cord, string, sheet, etc. and independently acts as a reinforcing part 40.

In this case, it is preferable to apply a predetermined tension to an insert member 45 while fastening the insert member 45 to the two ends of the core 11. Due to this, the core 11 is held compressed in the axial direction and separation of the electromagnetic steel sheets of the core 11 in the lamination direction can be further prevented.

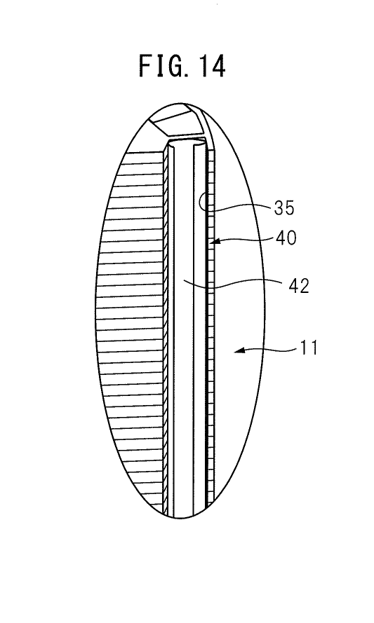

FIG. 14 is a ninth partial enlarged perspective view of a core. In FIG. 14, a prepreg sheet 46 which extends from one end to the other end of the core 11 is inserted in a non-core part 35. The prepreg sheet 46 is for example a carbon fiber sheet or glass fiber sheet in which a thermosetting resin is impregnated. Therefore, by heating a prepreg sheet 46 which is inserted into a non-core part 35, the prepreg sheet 46 can be made to harden and be fastened to the inside walls of the non-core part 35.

In the present invention, the reinforcing parts 40 are provided at the non-core parts 35 and 36, etc. Therefore, without requiring the rivet holes of the prior art and without lowering the strength of the rotor 10, the strength of the core 11 in the axial direction is raised. As a result, separation of the electromagnetic steel sheets of the core 11 in the lamination direction can be prevented. Further, the rivet holes of the prior art are not required, so the strength in the centrifugal force direction at the time of rotation will also not drop.

In particular, when a plurality of electromagnetic steel sheets are joined together by a binder, swaging, etc., the strength against peeling of the binder from the electromagnetic steel sheets is improved. Therefore, the trouble of electromagnetic steel sheets of the core 11 separating and breaking apart etc. can be eliminated.

Further, in particular, when bonding is used to join a plurality of electromagnetic steel sheets with each other, the larger the inside diameter of the core 11, the smaller the bonding area, so the strength of the core 11 in the axial direction generally falls. Therefore, the reinforcing parts 40 in present invention are particularly advantageous in the case of a core 11 with a small bonding area, that is, a core 11 with a large inside diameter.

Note that, the present invention is not limited to a rotor 10 which includes a core 11 comprised of a plurality of electrical steel sheets which are joined with each other by a binder, swaging, etc. All members which include a core which is formed by laminating a plurality of electromagnetic steel sheets are included in the scope of the present invention.

### Advantageous Effects of Invention

In the first aspect, reinforcing parts are provided at the non-core parts. Therefore, without requiring rivet holes and without lowering the strength of the rotor, the strength of the core in the axial direction can be raised and the electromagnetic steel sheets of the core can be prevented from separating in the lamination direction. Further, since rivet holes are not required, the strength in the centrifugal force direction at the time of rotation never falls.

In the second aspect, hardening of the first material enables the second material to also be fastened in the non-core parts, so the strength of the core in the axial direction can be raised.

Typical embodiments were used to explain the present invention, but it will be understood that a person skilled in the art could make the above-mentioned changes and various other changes, deletions, and additions without departing from the scope of the present invention.

1. An embedded magnet type electric motor rotor including a core which is formed by laminating a plurality of electrical steel sheets, magnets which are arranged in a plurality of magnet slots which are formed in a circumferential direction of said core, and non-core parts which are positioned in clearances between said magnet slots and said magnets which are arranged in said magnet slots, wherein in said rotor, reinforcing parts which reinforce said core in an axial direction are provided at least at two non-core parts of said core.

2. The rotor as set forth in claim 1, wherein
a said reinforcing part is comprised of at least a first material and a second material,
said first material is a material which has fluidity when filled in a said non-core part and which hardens after filling, and
said second material is at least one elongated member which extends at least partially in an axial direction at said non-core part.

3. The rotor as set forth in claim 2, wherein said second material is fiber.

4. The rotor as set forth in claim 2, wherein said second material is a fabric-shaped, mat-shaped, sheet-shaped, film-shaped, or felt-shaped material.

5. The rotor as set forth in claim 2, wherein said second material is a string-shaped, rod-shaped, or cord-shaped material.

6. The rotor as set forth in claim 2, wherein said second material is a rod-shaped or tube-shaped material.

7. The rotor as set forth in claim 1, wherein a said reinforcing part is an insert member which is inserted into said non-core part and extends from one end to the other end of said core, and tension is applied to said insert member in an axial direction of said core while said insert member is fastened to one end and the other end of said core.

8. The rotor as set forth in claim 1, wherein a said reinforcing part is a carbon fiber sheet which is inserted into said non-core part, extends from one end to the other end of said core, and is impregnated with a thermosetting resin and is fastened to said non-core part by heating to harden said carbon fiber sheet.

9. An electric motor which carries a rotor of claim 1.
